(19) United States
(12) Patent Application Publication
(10) Pub. No.: US 2015/0268750 A1
(43) Pub. Date: Sep. 24, 2015

(54) TOUCHSCREEN APPARATUS AND TOUCH SENSING METHOD

(71) Applicant: SAMSUNG ELECTRO-MECHANICS CO., LTD., Suwon-Si (KR)

(72) Inventors: Tae Hyeon KWON, Suwon-Si (KR); Kang Joo KIM, Suwon-Si (KR); Tah Joon PARK, Suwon-Si (KR)

(21) Appl. No.: 14/498,234

(22) Filed: Sep. 26, 2014

(30) Foreign Application Priority Data
Mar. 19, 2014 (KR) 10-2014-0031994

(51) Int. Cl. G06F 3/041

(52) U.S. Cl. CPC G06F 3/041

(57) ABSTRACT

A touchscreen apparatus may include a signal converting unit generating digital signals including a plurality of data according to changes in capacitance in a plurality of nodes;
a signal processing unit changing levels of the plurality of data of the digital signals; and a calculating unit determining a touch according to the digital signals output from the signal processing unit. The signal processing unit may change the levels of the plurality of data by using a portion of the plurality of data included in a plurality of regions partitioned according to a plurality of predetermined reference levels.

### CROSS-REFERENCE TO RELATED APPLICATION

This application claims the benefit of Korean Patent Application No. 10-2014-0031994 filed on Mar. 19, 2014, with the Korean Intellectual Property Office, the disclosure of which is incorporated herein by reference.

### BACKGROUND

The present disclosure relates to a touchscreen apparatus and a touch sensing method.

In general, a touchscreen apparatus such as a touchscreen, a touch pad, or the like, a user interface device attached to a display apparatus to provide an intuitive device interface method to a user, has recently been widely used in various electronic apparatuses such as cellular phones, personal digital assistants (PDAs), navigation apparatuses, and the like. Particularly, as demand for smartphones has recently increased, the use of touchscreens, as touch apparatuses capable of providing various device interface methods in a limited form factor has correspondingly increased.

Touchscreens used in portable apparatuses may mainly be divided into resistive type touchscreens and capacitive type touchscreens, according to a method of sensing a touch implemented therein. Here, capacitive type touchscreens have advantages in that a relatively long lifespan and various interface methods, such as hand gestures may be provided thereby, such that the use thereof has increased. Particularly, capacitive type touchscreens may more easily for allow for multi-touch device interactions, as compared with resistive type touchscreens, such that capacitive type touchscreens are currently widely used in apparatuses such as smartphones, and the like.

Capacitive type touchscreens commonly include a plurality of electrodes having a predetermined pattern and defining a plurality of nodes in which changes in capacitance are generated by a touch. In the plurality of nodes distributed on a two-dimensional plane, changes in self-capacitance or in mutual-capacitance are generated by the touch. Coordinates of the touch may be calculated by applying a weighted average method, or the like, to the changes in capacitance generated in the plurality of nodes.

Since a capacitive type touchscreen apparatus recognizes touches by sensing charges or changes in capacitance, such touchscreens may be vulnerable to noise introduced from the display apparatus. In order to a precisely sense touches in a relatively noisy environment, differences between an output signal in a node to which a touch is applied and an output signal in a node to which a touch is not applied should be relatively large. Particularly, recent touchscreen apparatuses have included functions for sensing a proximity touch such as a hover touch and a touch by a stylus. However, since the proximity touch and the stylus touch have relatively weak a changes in capacitance, as compared with a directly applied touches, there is a need to improve a signal to noise ratio (SNR).

### RELATED ART DOCUMENT

(Patent Document 1) Korean Patent Laid-Open Publication No. 2013-0113178

### SUMMARY

An exemplary embodiment in the present disclosure may provide a touchscreen apparatus and a touch sensing method capable of calculating a maximum expansion level and a minimum expansion level according to data of a portion of regions among a plurality of regions partitioned according to a plurality of reference levels and changing levels of a plurality of data so that the data level is present between the calculated maximum expansion level and minimum expansion level.

According to an exemplary embodiment in the present disclosure, a touchscreen apparatus may include: a signal converting unit generating digital signals including a plurality of data according to changes in capacitance in a plurality of nodes; a signal processing unit changing levels of the plurality of data of the digital signals; and a calculating unit determining a touch according to the digital signals output from the signal processing unit, wherein the signal processing unit changes the levels of the plurality of data according to data of a plurality of regions partitioned according to a plurality of predetermined reference levels among the plurality of data.

The signal processing unit may calculate a maximum expansion level and a minimum expansion level according to data of a portion of regions among the plurality of regions and may change the levels of the plurality of data so that the levels of the plurality of data are present between the maximum expansion level and the minimum expansion level.

The signal processing unit may change a level of data equal to the maximum expansion level or higher, among the plurality of data to the maximum expansion level, change a level of data lower than the minimum expansion level as the minimum expansion level, and change a level of data lower than the maximum expansion level or equal as the minimum expansion level or higher according to the following Equation:

$$TouchOut ( n ) = \frac{TouchIn ( n ) - LowValue}{HighValue - LowValue} \times MaxRange \qquad [ Equation ]$$

where TouchOut(n) denotes a level of data after being changed, TouchIn(n) denotes a level of data before being changed, HighValue denotes the maximum expansion level, LowValue denotes the minimum expansion level, and MaxRange denotes a maximum level that data of the digital signal has.

The plurality of reference levels may include a touch reference level, a first noise reference level, a second noise reference level, and an anti-touch reference level which are preset, and the touch reference level and the first noise reference level may be positive (+) based on a predetermined base line, the touch reference level may have a level higher than the first noise reference level, the second noise reference level and the anti-touch reference level may be negative (−) based on the base line, and the second noise reference level may have a level higher than the anti-touch reference level.

The signal processing unit may calculate the maximum expansion level by calculating an average value of data having a level equal to that of the touch reference level or above, among the plurality of data.

The signal processing unit may calculate the maximum expansion level by calculating an average value of data having a level equal to that of the touch reference level or above, among the plurality of data and multiplying the calculated average value by a predetermined scale coefficient.

The scale coefficient may be set so that the level of the maximum expansion level is lower than the maximum level of data of the digital signal.

The signal processing unit may set the maximum level of data of the digital signal, to the maximum expansion level in the case in which the data having a level equal to that of the touch reference level or above is not present among the plurality of data.

The signal processing unit may respectively perform a differential operation of an average value of the data lower than the first noise reference level and equal to the second noise reference level or higher, among the plurality of data with the data lower than the touch reference level and equal to the first noise reference level or higher, among the plurality of data, and may set a value having a highest absolute value among the calculated values as the minimum expansion level.

The signal processing unit may respectively perform a differential operation of an average value of the data lower than the first noise reference level and equal to the second noise reference level or higher, among the plurality of data with the data lower than the touch reference level and equal to the first noise reference level or higher and data lower than the anti-touch reference level among the plurality of data, and may set a value having a highest absolute value among the calculated values as the minimum expansion level.

The touchscreen apparatus may further include a filter unit filtering the digital signals output from the signal converting unit and transferring the filtered digital signals to the signal converting unit.

According to an exemplary embodiment in the present disclosure, a touchscreen apparatus may include: a signal converting unit generating digital signals including a plurality of data according to changes in capacitance in a plurality of nodes; a signal processing unit changing levels of the plurality of data of the digital signals; and a calculating unit determining a touch according to the digital signals output from the signal processing unit, wherein the signal processing unit changes the levels of the plurality of data so that the levels of the plurality of data are present between a maximum expansion level and a minimum expansion level calculated according to the plurality of data.

The signal processing unit may calculate the maximum expansion level and the minimum expansion level according to data of a portion of regions among a plurality of regions partitioned according to a plurality of reference levels which are preset.

The signal processing unit may change a level of data equal to the maximum expansion level or higher, among the plurality of data to the maximum expansion level, change a level of data lower than the minimum expansion level as the minimum expansion level, and change a level of data lower than the maximum expansion level or equal as the minimum expansion level or higher according to the following Equation:

$$TouchOut ( n ) = \frac{TouchIn ( n ) - LowValue}{HighValue - LowValue} \times MaxRange \qquad [ Equation ]$$

where TouchOut(n) denotes a level of data after being changed, TouchIn(n) denotes a level of data before being changed, HighValue denotes the maximum expansion level, LowValue denotes the minimum expansion level, and MaxRange denotes a maximum level that data of the digital signal has.

The plurality of reference levels may include a touch reference level, a first noise reference level, a second noise reference level, and an anti-touch reference level which are preset, and the touch reference level and the first noise reference level may be positive (+) based on a predetermined base line, the touch reference level may have a level higher than the first noise reference level, the second noise reference level and the anti-touch reference level may be negative (−) based on the base line, and the second noise reference level may have a level higher than the anti-touch reference level.

The signal processing unit may calculate the maximum expansion level by calculating an average value of data having a level equal to that of the touch reference level or above, among the plurality of data.

The signal processing unit may calculate the maximum expansion level by calculating an average value of data having a level equal to that of the touch reference level or above, among the plurality of data and multiplying the calculated average value by a predetermined scale coefficient.

The scale coefficient may be set so that the level of the maximum expansion level is lower than the maximum level of data of the digital signal.

The signal processing unit may set the maximum level of data of the digital signal, to the maximum expansion level in the case in which the data having a level equal to that of the touch reference level or above is not present among the plurality of data.

The signal processing unit may respectively perform a differential operation of an average value of the data lower than the first noise reference level and equal to the second noise reference level or higher, among the plurality of data with the data lower than the touch reference level and equal to the first noise reference level or higher, among the plurality of data, and may set a value having a highest absolute value among the calculated values as the minimum expansion level.

The signal processing unit may respectively perform a differential operation of an average value of the data lower than the first noise reference level and equal to the second noise reference level or higher, among the plurality of data with the data lower than the touch reference level and equal to the first noise reference level or higher and data lower than the anti-touch reference level among the plurality of data, and may set a value having a highest absolute value among the calculated values as the minimum expansion level.

The touchscreen apparatus may further include a filter unit filtering the digital signals output from the signal converting unit and transferring the filtered digital signals to the signal converting unit.

According to an exemplary embodiment in the present disclosure, a touch sensing method may include: generating digital signals including a plurality of data according to changes in capacitance in a plurality of nodes; changing levels of the plurality of data; and determining a touch according to the changed levels of the plurality of data, wherein in the changing of levels of the plurality of data, a maximum expansion level and a minimum expansion level are calculated according data of a plurality of regions partitioned according to a plurality of predetermined reference levels among the plurality of data and the levels of the plurality of data are changed so that the levels of the plurality of data are present between the calculated maximum expansion level and minimum expansion level.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating an exterior of an electronic device including a touchscreen apparatus according to an exemplary embodiment in the present disclosure;

FIG. 2 is a view illustrating a panel unit that may be included in the touchscreen apparatus according to an exemplary embodiment in the present disclosure;

FIG. 3 is a view illustrating a cross-section of the panel unit that may be included in the touchscreen apparatus according to an exemplary embodiment in the present disclosure;

FIG. 4 is a view illustrating a touchscreen apparatus according to an exemplary embodiment in the present disclosure; and

FIG. 5 is a view provided to describe a plurality of reference levels and regions partitioned according to the plurality of reference levels according to an exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

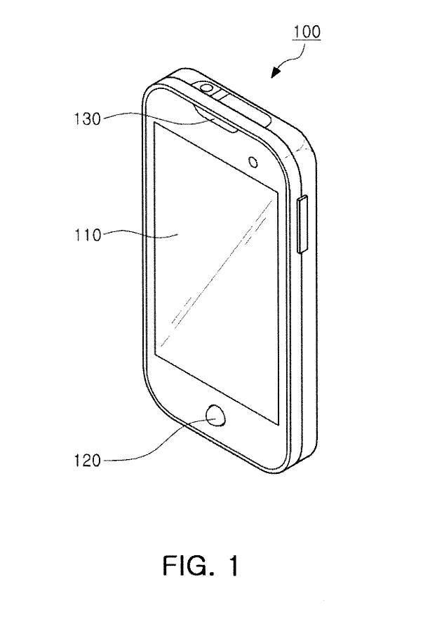

FIG. 1 is a perspective view illustrating an exterior of an electronic device including a touchscreen apparatus according to an exemplary embodiment in the present disclosure.

Referring to FIG. 1, an electronic device 100 according to the present exemplary embodiment may include a display apparatus 110 for outputting a screen, an input unit 120, an audio unit 130 for outputting an audio, and a touch sensing apparatus integrated with the display apparatus 110.

As illustrated in FIG. 1, in the case of a mobile device, the touch sensing apparatus may be generally integrated with the display apparatus and needs to have a high degree of light transmissivity to which an image passes through a screen displayed on the display apparatus. Therefore, the touch sensing apparatus may be implemented by forming an electrode using a transparent and electrically conductive material such as indium tin oxide (ITO), indium zinc oxide (IZO), zinc oxide (ZnO), carbon nano tube (CNT), or graphene on a base substrate formed of a transparent film material such as polyethylene terephtalate (PET), polycarbonate (PC), polyethersulfone (PES), polyimide (PI), a polymethyl methacrylate (PMMA), or the like. In addition, the electrode may be formed of fine conductive lines formed of any one of silver (Ag), aluminum (Al), chrome (Cr), nickel (Ni), molybdenum (Mo), and copper (Cu), or an alloy thereof.

The display apparatus may include a wiring pattern disposed on a bezel region thereof, wherein the wiring pattern is connected to the electrode. Since the wiring pattern is visually shielded by the bezel region, it may also be formed of a metal material such as silver (Ag), copper (Cu), or the like.

The touchscreen apparatus according to an exemplary embodiment in the present disclosure may be a capacitive type touchscreen apparatus and accordingly, it may include a plurality of electrodes having a predetermined pattern. Also, the touchscreen apparatus according to an embodiment in the present disclosure may include a capacitance detection circuit detecting changes in capacitance generated in the plurality of electrodes, an analog-to-digital conversion circuit converting an output signal from the capacitance detection circuit into a digital value, an operation circuit determining a touch by using data converted as the digital value, and the like.

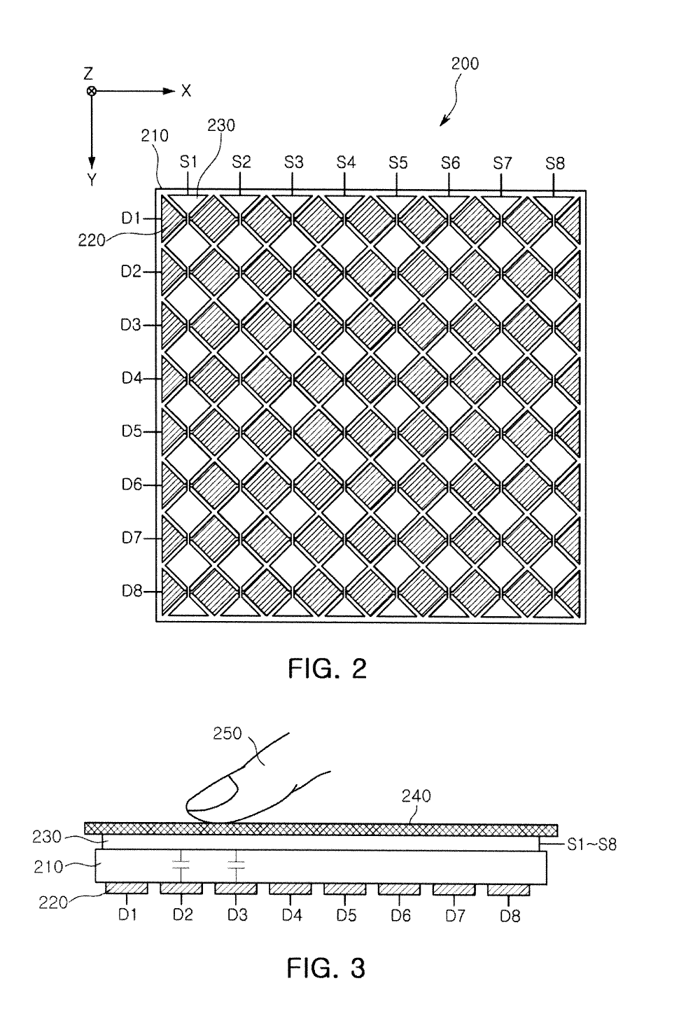

FIG. 2 is a view illustrating a panel unit that may be included in the touchscreen apparatus according to an exemplary embodiment in the present disclosure.

Referring to FIG. 2, the panel unit 200 according to the present exemplary embodiment may include a substrate 210 and a plurality of electrodes 220 and 230 provided on the substrate 210. Although not illustrated in FIG. 2, each of the plurality of electrodes 220 and 230 may be electrically connected to a wiring pattern of a circuit substrate attached to one end of the substrate 210 through wirings and a bonding pad. A controller integrated circuit (a controlling unit) is mounted on the circuit board to detect a sensing signal generated in the plurality of electrodes 220 and 230 and determine a touch from the sensing signal.

The plurality of electrodes 220 and 230 may be provided on one surface or both surfaces of the substrate 210. Although FIG. 2 shows a case in which the plurality of electrodes 220 and 230 have a rhomboid pattern or a diamond pattern, the plurality electrodes 220 and 230 may also have various polygonal patterns such as rectangular patterns, triangular patterns, or the like in addition to the above-mentioned patterns.

The plurality of electrodes 220 and 230 may include first electrodes 220 extending in an X axis direction and second electrodes 230 extending in a Y axis direction. The first electrodes 220 and the second electrodes 230 may intersect each other on both surfaces of the substrate 210, or on different substrates 210. In the case in which the first electrodes 220 and the second electrodes 230 are all formed on one surface of the substrate 210, predetermined insulating layers may be partially formed in intersections between the first electrodes 220 and the second electrodes 230.

Further, in addition to a region in which the plurality of electrodes 220 and 230 are formed, with respect to a region in which the wirings connected to the plurality of electrodes 220 and 230 are provided, a predetermined printed region for visually shielding the wiring generally formed of an opaque metal material may be formed on the substrate 210.

The apparatus electrically connected to the plurality of electrodes 220 and 230 to sense a touch may detect changes in capacitance generated in the plurality of electrodes 220 and 230 according to a touch applied thereto and sense the touch therefrom. The first electrode 220 may be connected to channels D1 to D8 in the controller integrated circuit to thereby have a predetermined driving signal applied thereto, and the second electrodes 230 may be connected to channels S1 to S8 to thereby be used for the touch sensing apparatus to detect sensing signals. In this case, the controller integrated circuit may detect the change in mutual-capacitance generated between the first electrode 220 and the second electrode 230 as the sensing signals.

FIG. 3 is a view illustrating a cross-section of the panel unit that may be included in the touchscreen apparatus according to an exemplary embodiment in the present disclosure. FIG. 3 is a cross-sectional view of the panel unit 200 of FIG. 2 taken along a Y-Z plane. The panel unit 200 may further include a cover lens 240 to which a touch is applied, in addition to the substrate 210 and the plurality of sensing electrodes 220 and 230 described with reference to FIG. 2. The cover lens 240 may be provided on the second electrode 230 used to detect the sensing signal and receive a touch applied from a touch object 250 such as a finger, or the like.

When the driving signals are applied to the first electrodes 220 through the channels D1 to D8, mutual capacitance may be generated between the first electrodes 220 to which the driving signals are applied and the second electrodes 230. When the touch object 250 touches the cover lens 240, a change in capacitance may be generated in the mutual capacitance generated between the first and second electrodes 220 and 230 that are adjacent to a region touched by the touch object 250. The changes in capacitance may be in proportion to the touch object 250 and an area of an overlapped region between the first electrodes 220 to which the driving signals are applied and the second electrode 230. In FIG. 3, the mutual capacitance generated between the first and second electrodes 220 and 230 connected to the channels D2 and D3, respectively, may be affected by the touch object 250.

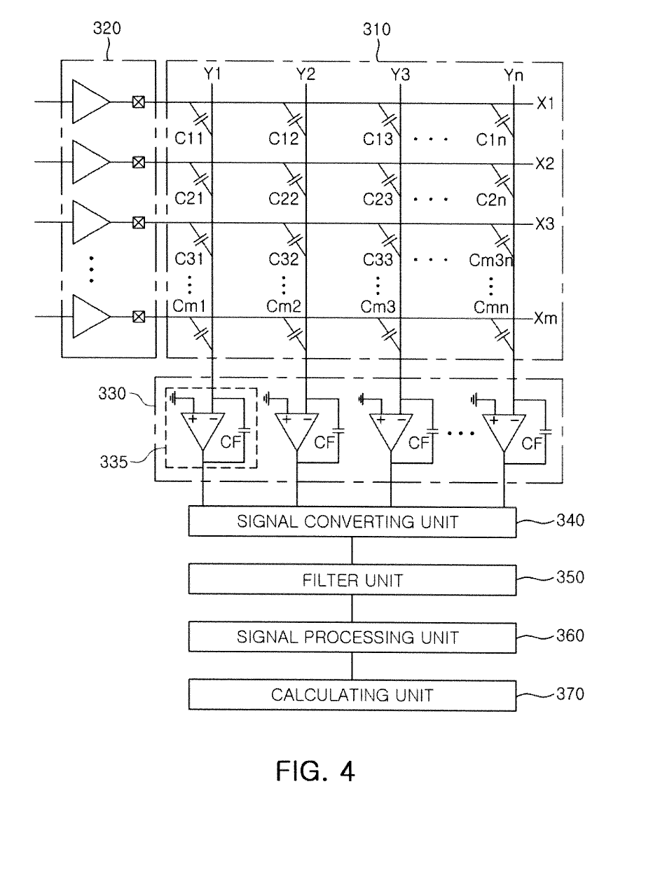

FIG. 4 is a view illustrating a touchscreen apparatus according to an exemplary embodiment in the present disclosure.

Referring to FIG. 4, the touchscreen apparatus according to the present exemplary embodiment may include a panel unit 310, a driving circuit unit 320, a sensing circuit unit 330, a signal converting unit 340, and a calculating unit 370. In this case, the driving circuit unit 320, the sensing circuit unit 330, the signal converting unit 340, and the calculating unit 370 may be implemented in a single integrated circuit (IC).

The panel unit 310 may include a plurality of rows of first electrodes X1 to Xm (driving electrodes) extended in a first axis direction (that is, a horizontal direction of FIG. 4) and a plurality of columns of second electrodes Y1 to Yn (sensing electrodes) extended in a second axis direction (that is, a vertical direction of FIG. 4) intersecting with the first axis. As described above, capacitances may be formed at the intersection points of the plurality of first electrodes X1 to Xm and the plurality of second electrodes Y1 to Yn. Node capacitors C11 to Cmn shown in FIG. 4 show capacitances generated at the intersection points of the plurality of first electrodes X1 to Xm and the plurality of second electrodes Y1 to Yn as capacitor components.

The driving circuit unit 320 may apply predetermined driving signals to the plurality of first electrodes X1 to Xm of the panel unit 310. The driving signals may be square wave signals, sine wave signals, triangle wave signals, or the like, having a predetermined period and amplitude and be sequentially applied to each of the plurality of first electrodes X1 to Xm. Although FIG. 4 shows a case in which circuits for generating and applying the driving signals are individually connected to each of the plurality of first electrodes X1 to Xm, a configuration in which the driving signal is applied to each of the plurality first electrodes X1 to Xm by including a single driving signal generating circuit and using a switching circuit may also be used. In addition, the touchscreen apparatus may be operated in a scheme in which the driving circuit unit 320 concurrently applies the driving signals to all of the first electrodes or selectively applies the driving signals to only a portion of the first electrodes to simply sense whether the touch is present or not.

The sensing circuit unit 330 may detect capacitances of the node capacitors C11 to Cmn from the plurality of second electrodes Y1 to Yn. The sensing circuit unit 330 may include a plurality of C-V converters 335 each including at least one operational amplifier and at least one capacitor, wherein each of the plurality of C-V converters 335 may be connected to the plurality of second electrodes Y1 to Yn.

The plurality of C-V converters 335 may convert the capacitances of the node capacitors C11 to Cmn to voltage signals to output analog signals. As an example, each of the plurality of C-V converters 335 may include an integrating circuit integrating the capacitances. The integrating circuit may integrate the capacitances and convert it to a predetermined voltage to output the predetermined voltage.

Although FIG. 4 shows a configuration of the C-V converter 335 in which a capacitor CF is disposed between an inverse terminal and an output terminal of the operational amplifier, an arrangement of the circuit configuration may also be changed. Further, although FIG. 4 shows a case in which the C-V converter 335 includes one operational amplifier and one capacitor, the C-V converter 335 may include a plurality of operational amplifiers and a plurality of capacitors.

In the case in which the driving signals are sequentially applied to the plurality of first electrodes X1 to Xm, since the capacitances may be concurrently detected from the plurality of second electrodes, the number of C-V converters 335 may correspond to the number n of the plurality of second electrodes Y1 to Yn.

The signal converting unit 340 may generate digital signals S_{D} from the analog signals output from the sensing circuit unit 330. As an example, the signal converting unit 340 may include a time-to-digital converter (TDC) circuit measuring a time in which the analog signal output in a voltage form by the sensing circuit unit 330 arrives at a predetermined reference voltage level and converting the measured time into the digital signal S_{D} or an analog-to-digital converter (ADC) circuit measuring an amount by which a level of the analog signal output from the sensing circuit unit 330 is changed for a predetermined time and converting the changed amount into the digital signal S_{D}.

The digital signal S_{D} may include a plurality of data according to the changes in capacitance at the respective nodes at which the plurality of first electrodes X1 to Xm and the plurality of second electrodes Y1 to Yn intersect with each other.

A filter unit 350 may digitally filter the digital signal output from the signal converting unit 340, wherein the filter unit 350 may include a median filter, a Gaussian filter, an infinite and finite impulse response filter, and various known filters.

A signal processing unit 360 may receive the digital signal from the signal converting unit 340 or may receive the filtered digital signal in the case in which the filter unit 350 is used, wherein the signal processing unit 360 may change a level of each of the plurality of data included in the received digital signal.

The signal processing unit 360 may change the level of each of the plurality of data according to data of a plurality of regions partitioned according to a plurality of reference levels. The plurality of reference levels are preset to classify a kind of data and the calculating unit 370 may determine the kind of data according to the plurality of reference levels.

The calculating unit 370 may determine a touch applied to the panel unit 310 using the digital signal output from the signal processing unit 360. The calculating unit 370 may determine the number, coordinates, gesture operations, or the like, of touches applied to the panel unit 310 using the digital signal.

The digital signal which is the basis for determining the touch by the calculating unit 370 may be data digitalizing the changes in capacitance of the node capacitors C11 to Cmn, and particularly, may be data indicating a capacitance difference between a case in which the touch is not generated and a case in which the touch is generated. Typically, in the capacitive type touchscreen apparatus, a region in which the conductive object touches has reduced capacitance as compared with a region in which the touch is not generated. Therefore, the region in which the conductive object touches may indicate the changes in capacitance larger than the region in which the touch is not generated.

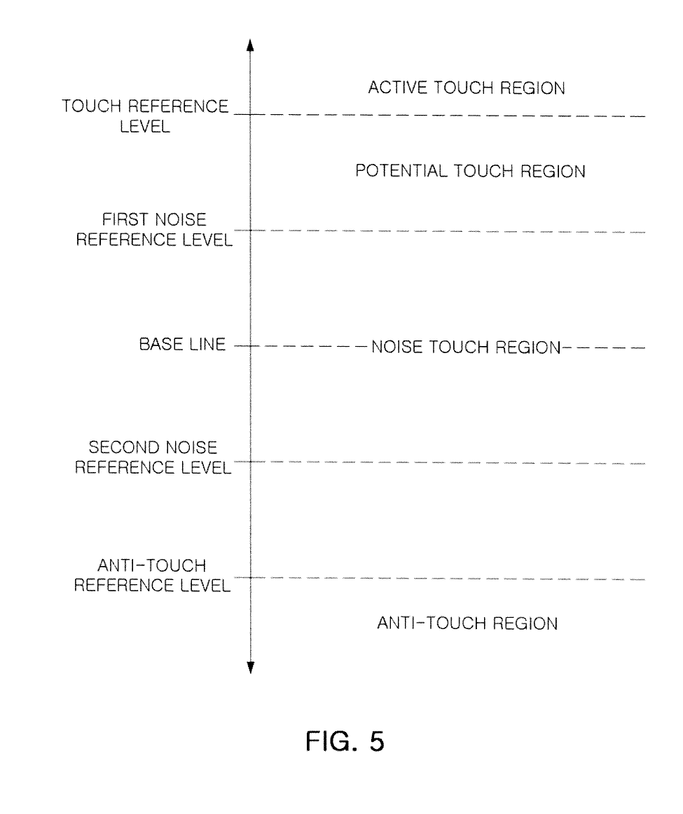

FIG. 5 is a view provided to describe a plurality of reference levels and regions partitioned according to the plurality of reference levels according to an exemplary embodiment in the present disclosure. Hereinafter, a method for adjusting levels of a plurality of data of the signal processing unit 360 and determining a kind of touches of the calculating unit 370 will be described with reference to FIG. 5.

The plurality of reference levels may include a touch reference level, first and second noise reference levels, and an anti-touch reference level. The touch reference level is a reference level for classifying data generated by an active touch applied by a user and other data, the first and second noise reference levels are a reference level for classifying data generated by noise, wherein data lower than a first noise reference level and is a second noise reference level or higher may be determined as the data generated by noise. The anti-touch reference level may correspond to a reference level for classifying data abnormally generated by signal distortion, or the like.

The touch reference level and the first noise reference level may be positive (+) based on a base line and the touch reference level may have a level higher than the first noise reference level. In addition, the second noise reference level and the anti-touch reference level may be negative (−) based on the base line and the second noise reference level may be lower than the anti-touch reference level. In this case, the base line may be preset to a zero (0) level or may be periodically updated by taking account of data by an operation environment or noise.

A plurality of digital data included in the digital signal may be classified into an active touch region, a potential touch region, a noise touch region, and an anti-touch region which are partitioned according to the plurality of reference levels.

Data having a level equal to that of the touch reference level or above based on the base line may be classified into the active touch region, data lower than the touch reference level and equal to the first noise reference level or higher is classified into the potential touch region, data lower than the first noise reference level and equal to the second noise reference level or higher is classified into the noise touch region, and data lower than the anti-touch reference level is classified into the anti-touch region.

The signal processing unit 360 may calculate a maximum expansion level and a minimum expansion level of data according to data of the regions determined according to the plurality of reference levels and may change levels of a plurality of data according to the calculated minimum expansion level and maximum expansion level.

The signal processing unit 360 may calculate the maximum expansion level by calculating an average value of the plurality of data belonging to the active touch region or may calculate the maximum expansion level by multiplying the calculated average value by a predetermined scale coefficient. In this case, the scale coefficient may be set to have the maximum expansion level lower than a maximum level that data of the digital signal may have and may be changed according to the average value of the plurality of data belonging to the active touch region.

However, when the data of the active touch region is not present, the maximum expansion level may be set to the maximum level that the data may have.

In addition, the signal processing unit 360 may set a maximum deviation value as the minimum expansion level by setting an average value of the noise touch region to a reference value. To this end, the signal processing unit 360 may respectively perform a differential operation of an average value of the plurality of data belonging to the noise touch region with a plurality of data belonging to the potential touch region, and may then select a value having a highest absolute value among the calculated values as the minimum expansion level.

In addition, in the case in which a plurality of data belonging to the anti-touch region are present, the signal processing unit 360 may respectively perform a differential operation of an average value of the plurality of data belonging to the noise touch region with a plurality of data belonging to the potential touch region and the anti-touch region, and may then select a value having a highest absolute value among the calculated values as the minimum expansion level.

The signal processing unit 360 may calculate the maximum expansion level and the minimum expansion level and may then change the levels of the plurality of data included in the digital signal according to the maximum expansion level and the minimum expansion level.

In this case, data having a level lower than the minimum expansion level among the plurality of data may maintain a level thereof, and data having a level higher than the maximum expansion level among the plurality of data may have a level changed to the maximum expansion level.

In addition, data having a level higher than the minimum expansion level and a level lower than the maximum expansion level among the plurality of data may have a level of data changed by the following Equation 1. In this case, TouchOut(n) denotes a level of data after being changed, TouchIn(n) denotes a level of data before being changed, HighValue denotes the maximum expansion level, LowValue denotes the minimum expansion level, and MaxRange denotes the maximum level that data of the digital signal may have.

$$TouchOut ( n ) = \begin{matrix}TouchIn ( n ) , & TouchIn ( n ) < LowValue \\ \frac{TouchIn ( n ) - LowValue}{HighValue - LowValue} \times MaxRange , & LowValue < TouchIn ( n ) < HighValue \\ HighValue , & TouchIn ( n ) > HighValue\end{matrix} \qquad [ Equation 1 ]$$

The calculating unit 370 may determine a kind of touches applied to the panel unit 310 using the digital signal output from the signal processing unit 360.

For the data of touch reference level or higher, the calculating unit 370 may determine that it is generated by an active touch, and for the data lower than the touch reference level and equal to the first noise reference level or higher, the calculating unit 370 may determine whether or not it is generated by the active touch through an additional algorithms. Since the data lower than the touch reference level and equal to the first noise reference level or higher may be generated by a touch of the user or noise, the calculating unit 370 may precisely determine whether the active touch is applied or not through a separate algorithms.

In addition, for the data lower than the first noise reference level and equal to the second noise reference level or higher, the calculating unit 370 may determine that it is generated by noise, wherein the base line, which is the reference level of data, may be periodically updated using the data lower than the first noise reference level and equal to the second noise reference level or higher.

For the data lower than the anti-touch reference level, the calculating unit 370 may determine that it is not generated by the touch of the user, but is generated by distortion of the signal, an introduction of an abnormal signal, a malfunction, or the like, to thereby remove the data lower than the anti-touch reference level or update the base line.

As set forth above, according to exemplary embodiments of the present disclosure, the difference between the levels of the plurality of data according to the changes in capacitance is increased, whereby the touch according to the fine change in capacitance may be precisely detected.

While exemplary embodiments have been shown and described above, it will be apparent to those skilled in the art that modifications and variations could be made without departing from the scope of the present invention as defined by the appended claims.

What is claimed is:

1. A touchscreen apparatus comprising:
a signal converting unit generating digital signals including a plurality of data according to changes in capacitance in a plurality of nodes;
a signal processing unit changing levels of the plurality of data of the digital signals; and
a calculating unit determining a touch according to the digital signals output from the signal processing unit
wherein the signal processing unit changes the levels of the plurality of data by using a portion of the plurality of data included in a plurality of regions partitioned according to a plurality of predetermined reference levels.

2. The touchscreen apparatus of claim 1, wherein the signal processing unit calculates a maximum expansion level and a minimum expansion level according to data included in a portion of regions among the plurality of regions and changes the levels of the plurality of data so that the levels of the plurality of data are present between the maximum expansion level and the minimum expansion level.

3. The touchscreen apparatus of claim 2, wherein the signal processing unit changes a level of data equal to the maximum expansion level or higher to the maximum expansion level, maintains a level of data lower than the minimum expansion level, and changes a level of data lower than the maximum expansion level or equal as the minimum expansion level or higher according to the following Equation, among the plurality of data:
$$TouchOut ( n ) = \frac{TouchIn ( n ) - LowValue}{HighValue - LowValue} \times MaxRange \qquad [ Equation ]$$
where TouchOut(n) denotes a level of data after being changed, TouchIn(n) denotes a level of data before being changed, HighValue denotes the maximum expansion level, LowValue denotes the minimum expansion level, and MaxRange denotes a maximum level that data of the digital signal has.

4. The touchscreen apparatus of claim 2, wherein the plurality of reference levels include a touch reference level, a first noise reference level, a second noise reference level, and an anti-touch reference level, and
the touch reference level and the first noise reference level be positive (+) based on a predetermined base line, the touch reference level has a level higher than the first noise reference level, the second noise reference level and the anti-touch reference level be negative (−) based on the base line, and the second noise reference level has a level higher than the anti-touch reference level.

5. The touchscreen apparatus of claim 4, wherein the signal processing unit calculates the maximum expansion level by calculating an average value of data having a level equal to that of the touch reference level or above, among the plurality of data.

6. The touchscreen apparatus of claim 4, wherein the signal processing unit calculates the maximum expansion level by calculating an average value of data having a level equal to that of the touch reference level or above, among the plurality of data, and multiplying the calculated average value by a predetermined scale coefficient.

7. The touchscreen apparatus of claim 6, wherein the scale coefficient is set so that the level of the maximum expansion level is lower than the maximum level of the plurality of data.

8. The touchscreen apparatus of claim 4, wherein the signal processing unit sets the maximum level of data of the digital signal, to the maximum expansion level in the case in which data having a level equal to that of the touch reference level or above is not present among the plurality of data.

9. The touchscreen apparatus of claim 4, wherein the signal processing unit respectively performs a differential operation of an average value of data lower than the first noise reference level and equal to the second noise reference level or higher, among the plurality of data, with the data lower than the touch reference level and equal to the first noise reference level or higher, among the plurality of data, and sets a value having a highest absolute value among the calculated values as the minimum expansion level.

10. The touchscreen apparatus of claim 4, wherein the signal processing unit respectively performs a differential operation of an average value of the data lower than the first noise reference level and equal to the second noise reference level or higher, among the plurality of data with the data lower than the touch reference level and equal to the first noise reference level or higher and data lower than the anti-touch reference level among the plurality of data, and sets a value having a highest absolute value among the calculated values as the minimum expansion level.

11. The touchscreen apparatus of claim 1, further comprising a filter unit filtering the digital signals output from the signal converting unit and transferring the filtered digital signals to the signal converting unit.

12. A touchscreen apparatus comprising:
a signal converting unit generating digital signals including a plurality of data according to changes in capacitance in a plurality of nodes;
a signal processing unit changing levels of the plurality of data of the digital signals; and
a calculating unit determining a touch according to the digital signals output from the signal processing unit,
wherein the signal processing unit changes the levels of the plurality of data so that the levels of the plurality of data are present between a maximum expansion level and a minimum expansion level calculated according to the plurality of data.

13. The touchscreen apparatus of claim 12, wherein the signal processing unit calculates the maximum expansion level and the minimum expansion level according to a portion of the plurality of data included in a portion of regions among a plurality of regions partitioned according to a plurality of reference levels which are preset.

14. The touchscreen apparatus of claim 12, wherein the signal processing unit changes a level of data equal to the maximum expansion level or higher, among the plurality of data to the maximum expansion level, maintains a level of data lower than the minimum expansion level, and changes a level of data lower than the maximum expansion level or equal as the minimum expansion level or higher according to the following Equation.
$$TouchOut ( n ) = \frac{TouchIn ( n ) - LowValue}{HighValue - LowValue} \times MaxRange \qquad [ Equation ]$$
where TouchOut(n) denotes a level of data after being changed, TouchIn(n) denotes a level of data before being changed, HighValue denotes the maximum expansion level, LowValue denotes the minimum expansion level, and MaxRange denotes a maximum level that data of the digital signal has.

15. The touchscreen apparatus of claim 13, wherein the plurality of reference levels include a touch reference level, a first noise reference level, a second noise reference level, and an anti-touch reference level which are preset, and
the touch reference level and the first noise reference level be positive (+) based on a predetermined base line, the touch reference level has a level higher than the first noise reference level, the second noise reference level and the anti-touch reference level be negative (−) based on the base line, and the second noise reference level has a level higher than the anti-touch reference level.

16. The touchscreen apparatus of claim 15, wherein the signal processing unit calculates the maximum expansion level by calculating an average value of data having a level equal to that of the touch reference level or above, among the plurality of data.

17. The touchscreen apparatus of claim 15, wherein the signal processing unit calculates the maximum expansion level by calculating an average value of data having a level equal to that of the touch reference level or above, among the plurality of data and multiplying the calculated average value by a predetermined scale coefficient.

18. The touchscreen apparatus of claim 17, wherein the scale coefficient is set so that the level of the maximum expansion level is lower than the maximum level of data of the digital signal.

19. The touchscreen apparatus of claim 15, wherein the signal processing unit sets the maximum level of data of the digital signal, to the maximum expansion level in the case in which the data having a level equal to that of the touch reference level or above is not present among the plurality of data.

20. The touchscreen apparatus of claim 15, wherein the signal processing unit respectively performs a differential operation of an average value of the data lower than the first noise reference level and equal to the second noise reference level or higher, among the plurality of data with the data lower than the touch reference level and equal to the first noise reference level or higher, among the plurality of data, and sets a value having a highest absolute value among the calculated values as the minimum expansion level.

21. The touchscreen apparatus of claim 15, wherein the signal processing unit respectively performs a differential operation of an average value of the data lower than the first noise reference level and equal to the second noise reference level or higher, among the plurality of data with the data lower than the touch reference level and equal to the first noise reference level or higher and data lower than the anti-touch reference level among the plurality of data, and sets a value having a highest absolute value among the calculated values as the minimum expansion level.

22. The touchscreen apparatus of claim 12, further comprising a filter unit filtering the digital signals output from the signal converting unit and transferring the filtered digital signals to the signal converting unit.

23. A touch sensing method comprising:
generating digital signals including a plurality of data according to changes in capacitance in a plurality of nodes;
changing levels of the plurality of data; and
determining a touch according to the changed levels of the plurality of data,
wherein in the changing of levels of the plurality of data, a maximum expansion level and a minimum expansion level are calculated according a portion of the plurality of data included in a plurality of regions partitioned according to a plurality of predetermined reference levels among the plurality of data and the levels of the plurality of data are changed so that the levels of the plurality of data are present between the calculated maximum expansion level and minimum expansion level.
